(19) United States
(12) Patent Application Publication
(10) Pub. No.: US 2026/0031550 A1
(43) Pub. Date: Jan. 29, 2026

(54) CRIMP CONTACT

(71) Applicant: HUBER+SUHNER AG, HERISAU (CH)

(72) Inventors: Franz MANSER, Herisau (CH); Jean-Philippe DELLEMANN, Busswil (CH)

(73) Assignee: HUBER+SUHNER AG, HERISAU (CH)

(21) Appl. No.: 18/993,269

(22) PCT Filed: Jul. 12, 2023
(86) PCT No.: PCT/EP2023/069312

§ 371 Date: Jan. 10, 2025

(30) Foreign Application Priority Data
Jul. 28, 2022 (CH) CH000908/2022

(51) Int. Cl. H01R 4/18; H01R 43/048

(52) U.S. Cl. CPC H01R 4/184; H01R 43/048

(57) ABSTRACT

A crimp contact, made from a plastically deformable material, which includes a connecting element merging into a tubular section. The tubular section provides a receiving space suitable to receive a conductor and extends away from the connecting element. The tubular section includes a first outer surface having a first outer diameter and a second outer surface having a second outer diameter with a transition surface interconnecting the first to the second outer surface. The tubular section includes an inner surface with a first inner section arranged adjacent to an end face terminating the receiving space and an adjacent second inner section corresponding to the second outer surface, wherein in an undeformed state the second outer diameter is larger than the first outer diameter, and in a deformed state, after plastic deformation of the tubular section by a crimping tool, the second inner section at least partially protrudes into the receiving space.

### BACKGROUND OF THE INVENTION

### Field of the Invention

The present disclosure relates to a crimp contact comprising a connecting element and a tubular section and a method for producing a crimp connection.

### Discussion of Related Art

GB 942144 A published by Amphenol Borg Electronics Corp. on 20 Nov. 1963 relates to a coaxial electrical connector attached to the end of a coaxial transmission line having a central conductor sheathed in a dielectric layer which layer is sheathed by a braided wire layer forming the outer conductor of the transmission line, the connector comprising a generally tubular metallic member having a thin-walled sleeve inserted between the dielectric layer and the braided wire layer at the end of the transmission line and a ferrule crimped over the braided wire and compressing the same against the thin-walled sleeve.

U.S. Pat. No. 6,976,889 published by Yazaki Corp. on 20 Dec. 2005 relates to a method of connecting a terminal with a wire in which a core of a wire is inserted into a tubular wire connecting portion of a terminal. The wire connecting portion is crimped in a radial direction of the wire, the wire connecting portion is compressed in a radial direction of the wire and uniformly over the whole circumference. While rotating dies by using a rotary swaging machine, the wire connecting portion is compressed by the dies in a radial direction of the wire and uniformly over the whole circumference. The wire connecting portion is compressed in a radial direction of the wire and uniformly over the whole circumference, and the outer periphery of a compressed part of the wire connecting portion has a true circular section shape.

### SUMMARY OF THE INVENTION

Crimp connections are known for attaching mechanical elements, such as an electrical conductor or the like, to a crimp contact or a connector. Crimp contacts typically comprise a connecting element like a pin or a plug and the actual crimp element, typically a collar or a sleeve, which crimp element forms a receiving space for the mechanical element. The connecting element can be e.g. designed as a pin (male contact) or a socket (female contact) or another crimp sleeve to connect two cable ends. Before the actual crimping process, the mechanical element like the electrical conductor, is usually arranged within the receiving space of the collar or a sleeve. During the crimping process the material of the crimp element is usually at least partially plastically deformed by a crimping tool, to attach e.g. the electrical conductor to the crimp contact.

To allow good plastic deformation of the crimp contact, cold formable ductile materials are usually preferred. Especially for electrical connections, connectors made of brass are widely used as they provide a good electrical conductivity and corrosion resistance. In many brass alloys lead is added which forms no solid solution in the matrix of the brass alloys, but disperses in a granular form, which has a positive impact on the machinability regarding cutting operations. Due to environmental considerations nowadays lead free brass alloys are required. To replace the lead typically silicon is added, which raises the easy-to-cut property but negatively impacts the plastic forming capability compared to brass alloys with lead. However, due to new environmental standards, the effort to reduce or fully avoid lead as alloy component became a challenge as the existing crimp contact geometries have proven to be unsuitable for more brittle and less deformable materials. A typical side effect of crimping operations with less ductile materials and alloys are micro cracks.

Therefore, one objective of the present disclosure is to provide a crimp contact, which can be made of less ductile materials compared to the prior art but still maintains a high performance of a crimp connection.

A crimp contact according to the present disclosure is usually made from a plastically deformable material. The crimp contact typically comprises a connecting element, e.g. a pin, which merges into a tubular section. The connecting element is preferably made in an integral manner with the tubular section, whereby the tubular section provides a receiving space suitable to receive a conductor or the like. The crimp contact can be made by one or several cutting operations, whereby the receiving space is usually made as a bore. Depending on the field of application, the crimp contact described hereinafter in more detail can be part of e.g. a cable connector. The tubular section that provides (encompasses) the receiving space is usually (before the plastic deformation by a crimping tool) designed as an essentially cylindrical hole. A usually flat or conical end face typically terminates the receiving space within the tubular section. Depending on the field of application, other geometries of the tubular section are possible as well, e.g. hexagonal outer shape. The diameter of the connecting element, e.g. a pin is typically smaller than the diameter of the first outer surface in the undeformed state. This allows a transition of forces without stress peaks in the transition area.

The tubular section extends in a longitudinal direction and typically comprises at least one first outer surface, which has a first outer diameter, which is typically arranged proximally to the connecting element and a neighboring second outer surface, which has a second outer diameter. In the undeformed state, the second outer diameter is usually larger than the first outer diameter as will be explained hereinafter in more detail. In a sectional view along the longitudinal direction, the tubular section typically has a staggered design. Good results regarding the stress distribution during the deformation and during use in the deformed state can be achieved when the first and the second outer surface do not merge into each other via a step, but via a smooth transition surface which interconnects the first outer surface and the second outer surface. On the inside, the tubular section has an inner surface with a first inner section arranged adjacent to the end face, terminating the receiving space, and an adjacent second inner section, typically corresponding to the second outer surface. As the receiving space is in the undeformed state of the crimp contact typically a cylindrical bore, the diameter of the first section and the diameter of the second section are typically similar at least before deformation.

One of the problems with the known geometries of the prior art is that sharp-edged tools can cause micro-cracks. A sharp transition in the area between the undeformed material and the deformed material which is caused by the edge of a crimping tool can cause stress peaks. In particular when the edge of the tool is applied axially close to the end face of the receiving space. The high stresses caused by the edge of the crimping tool engaging with the plastically deformable material can lead to cracking in less ductile materials. To reduce the stresses and thereby caused cracking, the edges of the crimping tool can be designed smooth, e.g. in form of a chamfer or rounding. Nevertheless, this makes customized and therefore expensive tools necessary.

Instead of rounding the edges of the tool, the transition surface interconnecting the first outer surface and the second outer surface can be designed as a sloped surface, with an outer diameter that smoothly merges from the first outer diameter into the second outer diameter. The gradual increase of the diameter of the transition surface leads to a smoother stress distribution during the crimping process. Good results regarding the stress distribution can be achieved when the proximal end of the second outer surface is spaced a distance away from the end face which is at least equal to the wall thickness of the tubular section between the second outer surface and the second inner section in the undeformed state. The proximal end of the second outer surface is typically the end, which is along the longitudinal direction, arranged proximally to the connecting element. To avoid a stress peak at the transition between the end face and the tubular section, the outer geometry can be designed such that the first outer surface in the longitudinal direction extends from the connecting element beyond the end face such that the transition surface is spaced a distance away from the end face.

The second outer surface is usually the surface to which the crimping tool is primarily applied. Depending on the design of the crimping tool, at least the second outer surface and the transition surface interconnecting the first and the second outer surface, are deformed. The second outer surface can e.g. be cylindrical or barrel shaped or the like providing an appropriate contact surface for the crimping tool. In a variation, the overall outer surface of the tubular section is bossed. If appropriate, the second outer surface can be subdivided into several sections. In a variation, the second outer surface may e.g. be divided by an annular groove and/or a recess extending in a longitudinal direction. The annular groove can be designed as a groove having an e.g. V-shaped cross-section, which subdivides the second outer surface into two cylindrical surfaces, which are separated by the groove. In the deformed state, after plastic deformation, the material between the two cylindrical surfaces and the inner surface can deformed into the receiving space configured to form wave-shaped protrusions. Alternatively, or in addition the first outer surface and the second outer surface can be separated from each other by a recess, e.g. designed as an annular groove.

During the crimping process, the second outer surface is typically only partially (locally) deformed in circumferential direction. The areas of the second outer surface which are in contact with the crimping tool and the material beyond are plastically deformed which causes deformation zones. During the deformation the at least one deformation zone is formed by plastically deforming the material between the second outer surface and the inner surface of the tubular section. The material is thereby deformed into the receiving space, forming at least one protrusion. For attaching a conductor to the crimp contact, the protrusions can be formed such that they are forced into the shell surface of the conductor and thereby form indentations in the shell surface of the conductor. The interaction between the protrusions and the indentations creates a form-fit connection. One of the advantages of the design is that simple tools, e.g. portable tools in form of crimping pliers sharp-edged press jaws can be used. Alternatively, instead of applying the crimping force locally on the second outer surface via crimping tools with at least two press jaws, crimping tools with a hexagonal shape of the press jaws (Hex-Crimp) in the closed state can be used. Alternatively, to tools with two press jaws, rotary swaging can be applied for crimping the tubular section.

A sharp transition having negative effect can be avoided when the at least one deformation zone at the second outer surface is spaced a first distance apart from the end face of the receiving space which first distance is preferably at least 50% of a second distance between the second outer surface and the second inner section. Depending on the geometry and the material, the distance can be as little as zero. Good results can be achieved when the deformation zones are deformed into the second outer surface no more than 50% of the overall deformation of the plastically deformable material between the second outer surface and the second inner section. This ration corresponds to a third distance between the defamation zone and the first outer surface which third distance is at less than 50% of a fourth distance between the first inner section and the second inner section. The second outer surface is configured to be in the deformed state after crimping at least partially deformed, thereby forming at least one deformation zone with a maximum distance between the at least one deformation zone and the first outer surface being less than 50% of a distance between the at least one deformation zone and the second inner section.

Good results can be achieved, when the transition surface, which interconnects the first outer surface and the second outer surface, is in the undeformed state designed as a sloped surface. The transition surface can be angled with respect to the longitudinal direction with an angle between 15° and 45°, preferably between 15° and 30°. Typically, the transition surface may have an outer diameter, which smoothly merges from the first outer diameter into the second outer diameter. During a usual plastic deformation process, when crimping the sleeve, the plastically deformable material arranged between the inner sections and outer surfaces is at least partially deformed. Typically, the crimping tool is applied to the second outer surface and causes first the plastically deformable material between the second outer surface and the second inner section to be at least partially deformed radially inwardly into the receiving space. Depending on the design, the transition surface starting at the proximal end of the second outer surface can either merge into the first outer surface beyond the end face or before the end face.

A thread and/or at least one annular grove can be arranged at the second inner section. For increasing the load bearing capabilities of the crimp connection, the thread and/or annular grove is pressed into the conductor during the plastic deformation, whereby bulges are formed on the shell surface of the conductor which engage with the thread and/or annular groves. This kind of form fit connection is especially beneficial with regard to pull-out forces occurring along the longitudinal direction.

A method for producing a crimp connection can comprise the following method steps:
providing a crimp contact according to at least one of the preceding claims;
providing a conductor and arranging an end section of the conductor within the receiving space of the tubular section of the crimp contact;
placing the crimp contact with the therein arranged end section of the conductor in a crimping tool;
applying a crimping force on the second outer surface of the tubular section and thereby at least partially deforming the plastically deformable material arranged between the second outer surface and the second inner section of the inner surface into the receiving space to form a form fit connection between the end section of the conductor and the crimp contact; and
the crimping force is applied on the second outer surface by at least one press jaw of the crimping tool which press jaw forms the at least one deformation zone in the second outer surface.

Depending on the geometry of the crimping tool, the crimping force can be applied circumferentially distributed or locally on the second outer surface. With a crimp tool consisting of two or more press jaws moving radially inwardly against each other, the crimp force is typically applied locally onto the second outer surface. Locally is thereby to be understood as only partially, leading to at least a partial deformation of the second outer surface, typically in form of indentations. Good results can be achieved when the crimping force is applied concentrated on several distinct areas of the second outer surface. As a consequence, in a deformed state the second inner section in the deformed state usually comprises protrusions which protrude into the receiving space and increase the form fit interconnection.

In a variation, the crimping tool is designed in a manner such that the crimp force can be applied to the second outer surface and the transition surface between the first and the second outer surface and/or the transition surface between the third and the second outer surface. In a variation, the crimp force is applied locally on the second outer surface forming deformation zones by partially engaging the press jaws with the second outer diameter. In the deformed state the shortest distance from the center axis of the crimp contact to the respective deformation zones can be equal to the radius of the first outer diameter.

Good results can be achieved when the crimping tool comprises press jaws having a square cross section in the closed state. Alternatively, also press jaws forming a hexagonal crimp geometry are possible. For crimp tools with a square or hexagonal shaped cross section, the tools typically consist of two press jaws. Alternatively, segment forming can be used for the crimp connection wherein the tool consists of several radially closing segments. To realize an essentially round crimp geometry a rotary swaging tool can be used, whereby most of the plastically deformable material arranged between the second outer surface and the second inner segment is deformed by several dies, which rotate with respect to the longitudinal direction and evert the plastically deformable material. In addition, to leverage the increased properties regarding the machinability, the crimp contact may be entirely made by material cutting processes. The crimp contact is typically made from a cylindrical semi-finished product by lathing, whereby the receiving space is made as a counter-bore, which is arranged along the longitudinal direction after lathing the outer geometry of the tubular section.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF SEVERAL VIEWS OF THE DRAWINGS

The herein described disclosure will be more fully understood from the detailed description given herein below and the accompanying drawings which should not be considered limiting to the disclosure described in the appended claims.

FIG. 1 shows a first variation of the crimp contact in the deformed state in a perspective view from the front and above with a partial cut-out;

FIG. 2 shows a lateral view of the first variation of the crimp contact according to FIG. 1;

FIG. 3 shows an enlarged cut-out of the first variation of the crimp contact according to FIG. 2;

FIG. 4a shows a second variation of the crimp contact in the undeformed state in a perspective view from the front and above;

FIG. 4b shows a second variation of the crimp contact in the undeformed state in a sectional lateral view;

FIG. 5a shows the second variation of the crimp contact in the deformed state in a perspective view from the front and above;

FIG. 5b shows the second variation of the crimp contact in the deformed state in a sectional lateral view;

FIG. 6 shows the second variation of the crimp contact according to FIGS. 4a and 4b in a perspective view from the front and above with a partial cut-out;

FIG. 7 shows the second variation of the crimp contact according to FIGS. 5a and 5b in a perspective view from the front and above with a partial cut-out;

FIG. 8 shows a third variation of the crimp contact in the undeformed state in a perspective view from the front and above with a partial cut-out;

FIG. 9 shows the third variation of the crimp contact in the deformed state in a perspective view from the front and above with a partial cut-out;

FIG. 10a shows the first variation of the crimp contact in the undeformed state in a crimping tool as a front view;

FIG. 10b shows the first variation of the crimp contact in the undeformed state in a crimping tool as a sectional lateral view;

FIG. 11a shows the first variation of the crimp contact in the deformed state in the crimping tool as a front view;

FIG. 11b shows the first variation of the crimp contact in the deformed state in the crimping tool as a sectional lateral view;

FIG. 12a shows the second variation of the crimp contact in the undeformed state in a crimping tool as a front view;

FIG. 12b shows the second variation of the crimp contact in the undeformed state in a crimping tool as a sectional lateral view;

FIG. 13a shows the second variation of the crimp contact in the deformed state in the crimping tool as a front view;

FIG. 13b shows the second variation of the crimp contact in the deformed state in the crimping tool as a sectional lateral view;

FIG. 14a shows the third variation of the crimp contact in the undeformed state in a crimping tool as a front view;

FIG. 14b shows the third variation of the crimp contact in the undeformed state in a crimping tool as a sectional lateral view;

FIG. 15a shows the third variation of the crimp contact in the deformed state in the crimping tool as a front view;

FIG. 15b shows the third variation of the crimp contact in the deformed state in the crimping tool as a sectional view;

FIG. 16a shows a fourth variation of the crimp contact in the undeformed state in a crimping tool as a front view;

FIG. 16b shows a fourth variation of the crimp contact in the undeformed state in a crimping tool as a sectional lateral view;

FIG. 17a shows the fourth variation of the crimp contact in the deformed state in the crimping tool as a front view; and

FIG. 17b shows the fourth variation of the crimp contact in the deformed state in the crimping tool as a sectional lateral view.

### DETAILED DESCRIPTION OF THE INVENTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

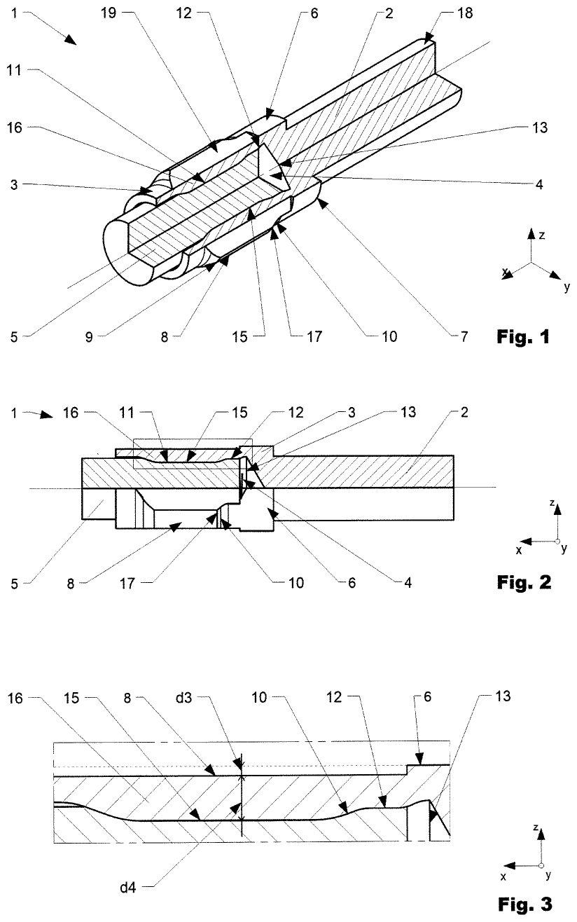

FIGS. 1 to 3 show a first variation of the crimp contact 1. The shown crimp contact 1 is made from a plastically deformable material and comprises a connecting element 2 and a tubular section 3 which tubular section provides a receiving space 4. The receiving space 4 is configured to receive a conductor 5. The tubular section 3 extends in the longitudinal direction x and comprises on the outside a first outer surface 6 which has a first outer diameter 7 and an adjacent second outer surface 8 which has a second outer diameter 9. As can be obtained from FIGS. 2 and 3, in the deformed state the second outer surface 8 of the shown crimp contact 1 is locally plastically deformed in the circumferential direction by a crimping tool. The thereby formed deformation zones 19 are indentations in the second outer surface 8. In the shown variation, the at least one deformation zone 19 at the second outer surface 8 is spaced a first distance d1 away from the end face 13 of the receiving space 4. The first distance d1 of the shown variation is at least 50% of a second distance d2 between the second outer surface 8 and the second inner section 15.

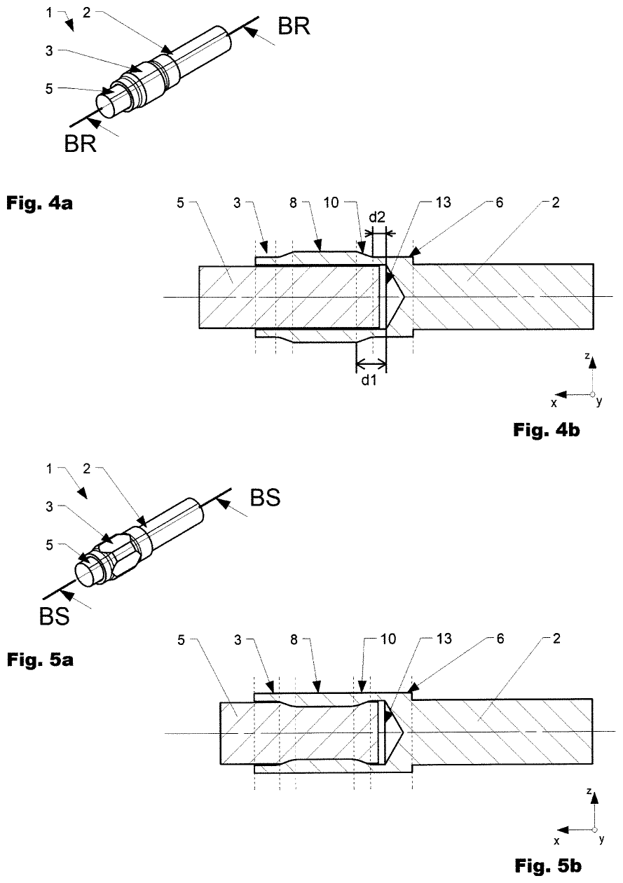

FIGS. 4 to 7 show a second variation of the crimp contact 1. The shown crimp contact 1 is as well made from a plastically deformable material and also comprises a connecting element 2 and a tubular section 3 providing a receiving space 4 suitable to receive a conductor 5. The tubular section 3 extends in the longitudinal direction x and comprises on the outside a first outer surface 6 which has a first outer diameter 7 and an adjacent second outer surface 8 which has a second outer diameter 9. On the inside, the tubular section 3 comprises an inner surface 11, which comprises in the longitudinal direction x a first inner section 12 and an adjacent second inner section 15 which corresponds to the second outer surface 8. As can be obtained best from FIG. 4b, the second outer diameter 9 of the tubular section 3 is in the undeformed state larger than the first outer diameter 7. As can be obtained best from FIG. 5b, in the deformed state, after plastic deformation of the shown crimp contact 1 by a crimping tool, the diameter of the second inner section 15 is smaller than the diameter of the first inner section 12.

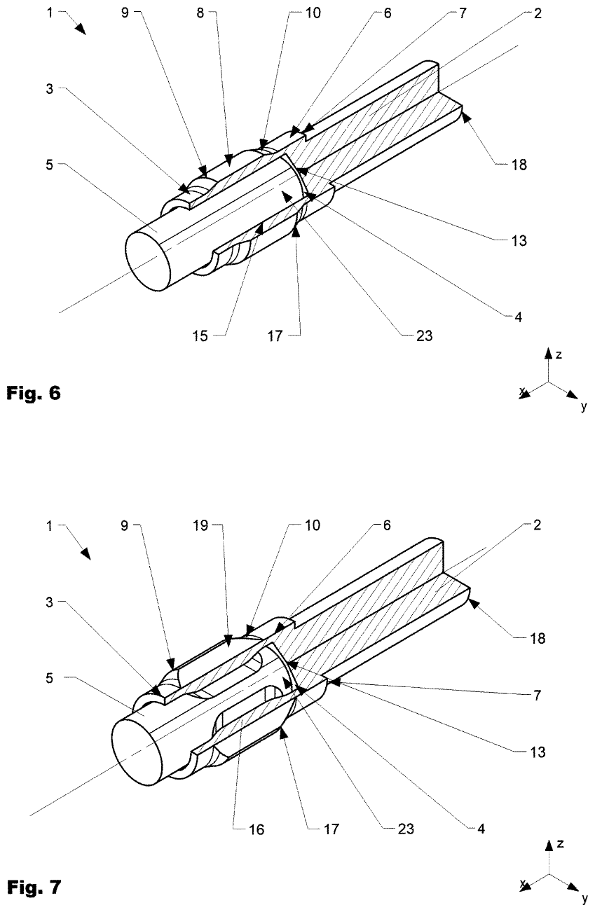

As can be obtained from FIGS. 6 and 7, to be able to attach the conductor 5, the receiving space 4 is suitable to receive an end section of the conductor 5. The receiving space 4 is made as a counter-bore which is arranged in the longitudinal direction x after lathing the outer geometry of the tubular section 3. The first inner section 12 of the inner surface 11 is arranged adjacent to the end face 13, which limits the receiving space 4 in the longitudinal direction x. In the undeformed state the second outer diameter 9 is larger than the first outer diameter 7 and the diameter of the second inner section 15 is equal or smaller than the diameter of first inner section 12. A transition surface 10 interconnects the first outer surface 6 and the second outer surface 8. In the shown variation, the transition surface 10 is designed as a sloped surface which is angled with respect to the longitudinal direction x with an angle between 15° and 45°, preferably between 15° and 30°. As can be obtained from FIG. 7, the crimping force is preferably applied locally on the second outer surface 8 forming deformation zones 19 by e.g. press jaws 25 which are engaged with the second outer surface 8. In the deformed state the deformation zones 19 are indentations in the second outer surface 8 and protrusions 16 at the inner surface 11 which protrude into the receiving space 4. The protrusion 16.

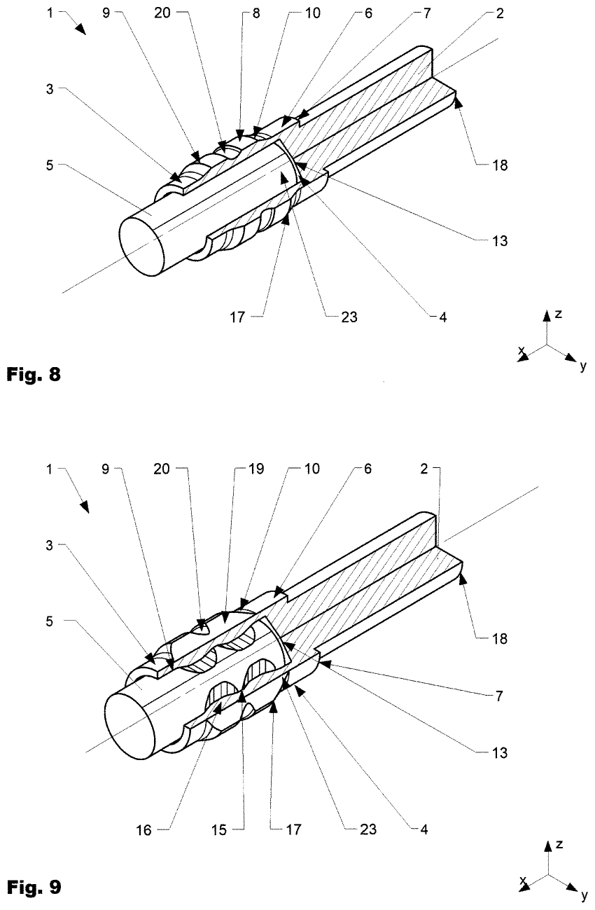

FIGS. 8 and 9 show a third variation of the crimp contact 1. Similar to the first and second variation, the tubular section 3, the first outer surface 6 and the second outer surface 8 are arranged adjacent to each other along the longitudinal direction x merge into each other. The second inner section 15 is arranged adjacent to the first inner section 12, which second inner section 15 corresponds to the second outer surface 8. As can be obtained best from FIG. 8, the second outer surface 8 of the shown variation is designed as a cylindrical surface, which is subdivided into several sections by an annular groove 26 or alternative or in addition by a recess extending in the longitudinal direction x. The annular groove 28 is designed as an essentially V-shaped groove, which subdivides the second outer surface 8 in two equal cylindrical surfaces. The shown first inner section 10 merges into an end face 25, which limits the receiving space 4 in longitudinal direction x.

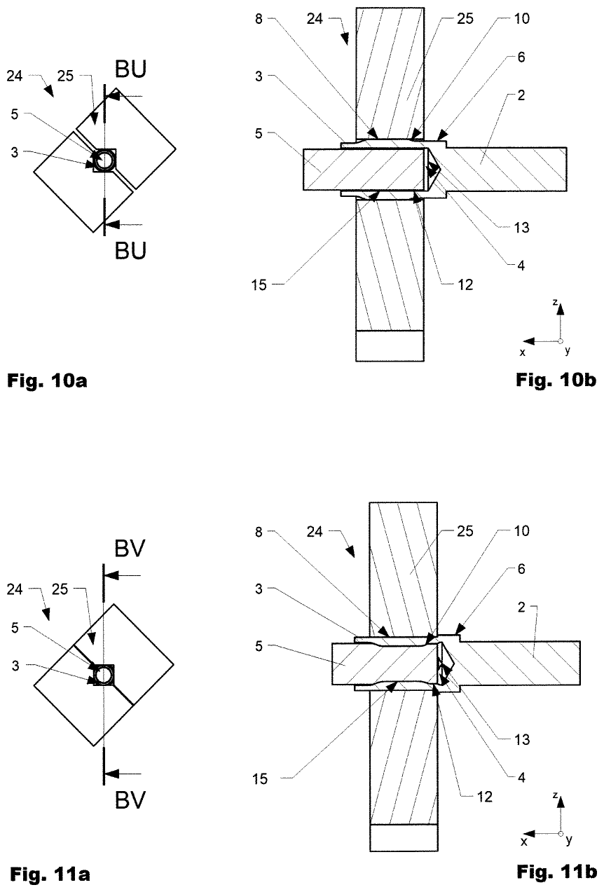

FIGS. 10 to 17 show the crimping method with various variations of the crimp contact 1. In all variation the crimping force is primarily applied to the second outer surface 8 of the crimp contacts 1, such that in the deformed state the first outer surface 6 remains essentially undeformed while the plastically deformable material arranged between the second inner section 15 and the second outer surface 8 is at least partially deformed into the receiving space 4. For producing the crimp connection the conductor 5 is provided and an end section of the conductor 5 is arranged within the receiving space 4 of the provided crimp contact 1. For crimping the conductor 5 to the crimp contact 1, the tubular section 3 with the therein arranged end section of the conductor 5 is placed in the crimping tool 24. A crimp force is applied on the second outer surface 8 of the tubular section 3 whereby the plastically deformable material arranged between the second outer surface 8 and the second inner section 15 is at least partially deformed into the receiving space 4 to form a form fit connection between the end section of the conductor 5 and the crimp contact 1.

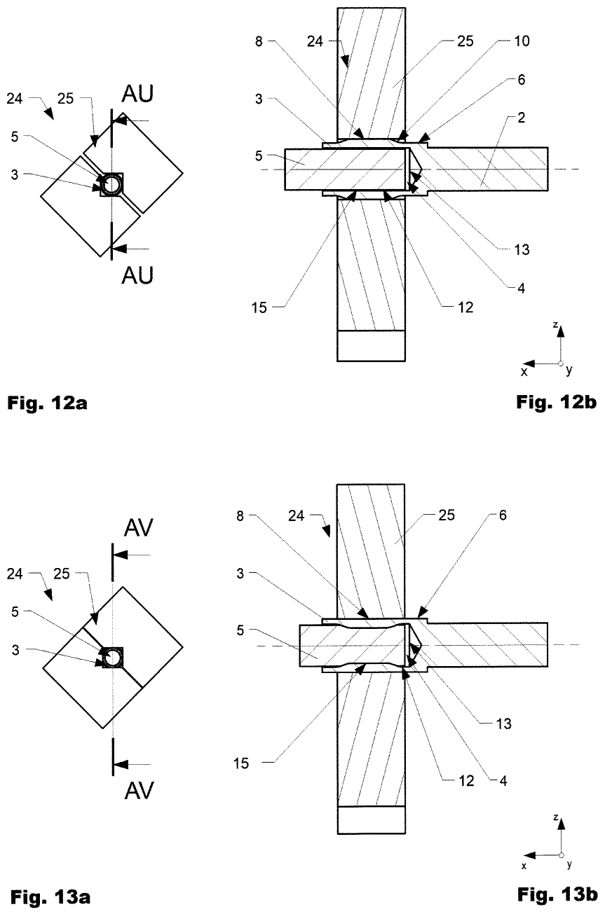

As can be obtained from FIGS. 10 and 11, a sharp transition can be avoided when the at least one deformation zone 19 at the second outer surface 8 is spaced a first distance d1 apart from the end face 13 of the receiving space 4. The first distance d1 is preferably at least 50% of a second distance d2 between the second outer surface 8 and the second inner section 15. The shown deformation zones 19 are deformed into the second outer surface 8 no more than 50% of the overall deformation of the plastically deformable material between the second outer surface 8 and the second inner section 15. As can be obtained from FIGS. 12 and 13, the difference between the first and the second variation is essentially the degree of plastic deformation. While in the first variation the plastically deformable material is deformed such that indentations are created in the second outer surface 8, in the second variation the plastically deformable material is only deformed in a manner such that deformations zones 19 merge into the first outer surface 6.

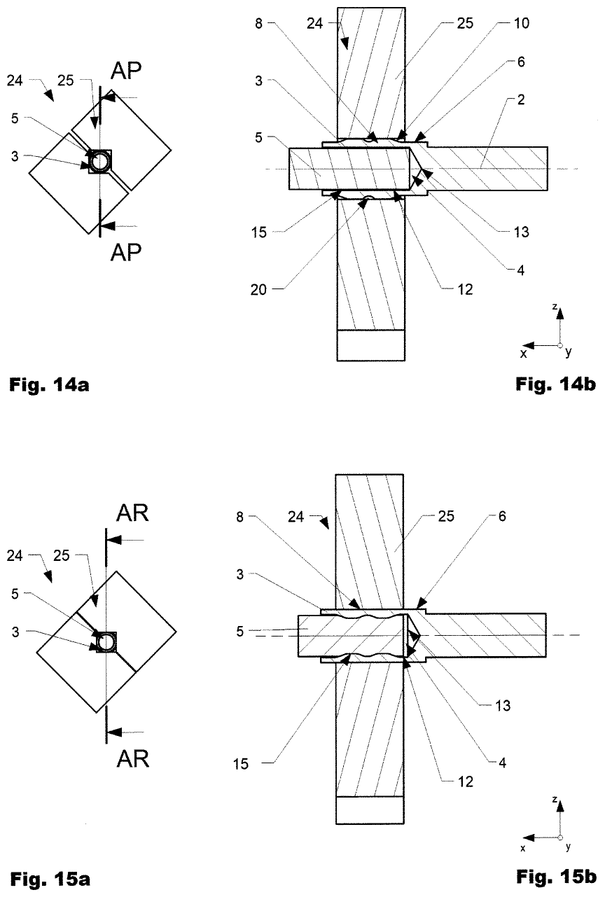

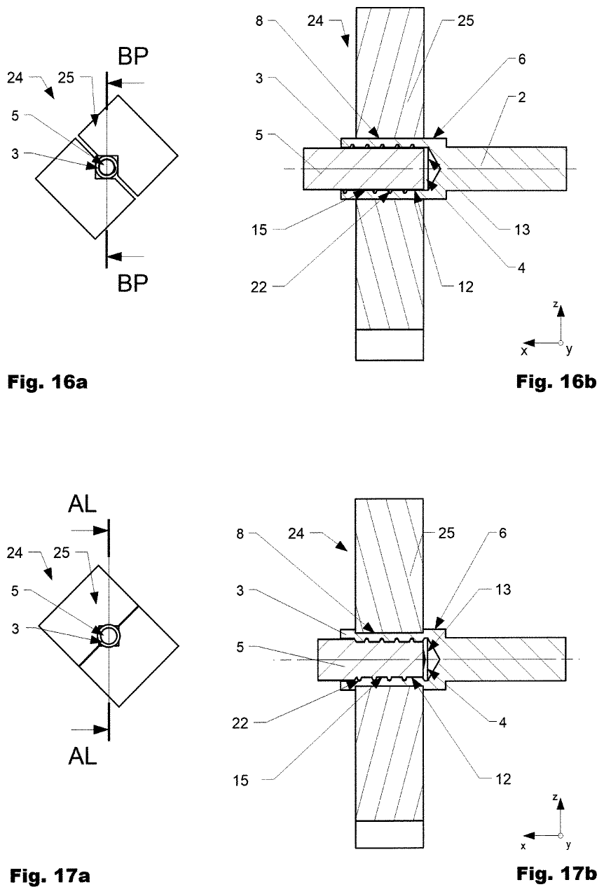

As can be obtained best from FIGS. 14 and 15 the second outer surface 8 of the shown variation is cylindrical and subdivided into several sections. The second outer surface 8 is divided by an annular groove 20. The annular groove 20 is designed as a groove having an e.g. V-shaped cross-section, which subdivides the second outer surface into two cylindrical surfaces, which are separated by the groove 20. As can be obtained from FIG. 15, in the deformed state after the plastic deformation, the inner surface 11 has a wave like shape. This kind of form fit connection between the deformed inner surface 11 and the conductor 5 is beneficial with regard to pull-out forces occurring along the longitudinal direction x. As can be obtained from FIGS. 16 and 17, for additionally increasing the crimping effect, the tubular section 3 can comprise a thread 22 and/or annular grooves, which are arranged at the second inner section 15. In the deformed state, the thread 22 and/or annular groves are pressed into the conductor 5 whereby by the plastic deformation of the shell surface of the conductor 5, bulges are formed which engage with the thread 22 and/or annular groves. This kind of form fit connection is also beneficial with regard to pull-out forces occurring along the longitudinal direction x.

Rather, the words used in the specification are words of description rather than limitation, and it is understood that various changes may be made without departing from the Spirit and scope of the disclosure.

1. A crimp contact made from a plastically deformable material, comprising a connecting element merging into a tubular section which provides a receiving space suitable to receive a conductor,
a. the tubular section extends in an longitudinal direction away from the connecting element and comprises:
i. on the outside a first outer surface having a first outer diameter and a neighboring second outer surface having a second outer diameter with a transition surface interconnecting the first outer surface to the second outer surface, and
ii. on the inside an inner surface with a first inner section arranged adjacent to an end face terminating the receiving space and an adjacent second inner section corresponding to the second outer surface, wherein
1. in an undeformed state the second outer diameter is larger than the first outer diameter and
2. in a deformed state, after plastic deformation of the tubular section by a crimping tool, the second inner section at least partially protrudes into the receiving space.

2. The crimp contact according to claim 1, wherein the transition surface is in the undeformed state designed as a sloped surface with an outer diameter that smoothly merges from the first outer diameter into the second outer diameter.

3. The crimp contact according to claim 1, wherein the second outer surface is cylindrical or barrel shaped.

4. The crimp contact according to claim 1, wherein the plastically deformable material between the second outer surface and the second inner section is configured to be at least partially deformed radially inwardly into the receiving space during crimping.

5. The crimp contact according to claim 4, wherein in the deformed state the second inner section of the inner surface comprises protrusions which protrude into the receiving space configured to attach the therein arranged conductor by a form-fit connection.

6. The crimp contact according to claim 1, wherein a proximal end of the second outer surface is spaced a distance away from the end face, said distance being at least equal to the wall thickness of the tubular section between the second outer surface and the second inner section in the undeformed state.

7. The crimp contact according to claim 1, wherein the first outer surface in the longitudinal direction extends from the connecting element beyond the end face such that the transition surface is spaced a distance away from the end face.

8. The crimp contact according to claim 1, wherein the diameter of the connecting element is at least 20% shorter than the diameter of the first outer surface in the undeformed state.

9. The crimp contact according to claim 1, wherein the second outer surface is configured to be in the deformed state after crimping at least partially deformed, thereby forming at least one deformation zone with a maximum distance between the at least one deformation zone and the first outer surface being less than 50% of a distance between the at least one deformation zone and the second inner section.

10. The crimp contact according to claim 1, wherein the second outer surface is in the undeformed state divided by at least one of an annular groove or a recess extending in the longitudinal direction.

11. The crimp contact according to claim 1, wherein at least one of a thread and at least one annular grove is arranged at the second inner section.

12. The crimp contact according to claim 1, wherein the crimp contact is made by a material cutting process.

13. A method for producing a crimp connection comprising the following method steps:
a. providing a crimp contact according to claim 1;
b. providing a conductor and arranging an end section of the conductor within the receiving space of the tubular section of the crimp contact;
c. placing the crimp contact with the therein arranged end section of the conductor in a crimping tool;
d. applying a crimping force on the second outer surface of the tubular section and thereby at least partially deforming the plastically deformable material arranged between the second outer surface and the second inner section of the inner surface into the receiving space to form a form fit connection between the end section of the conductor and the crimp contact.

14. The method for producing a crimp connection according to claim 13, wherein the crimping force is applied on the second outer surface by at least one press jaws of the crimping tool which press jaw forms the at least one deformation zone in the second outer surface.

15. The method for producing a crimp connection according to claim 13, wherein the crimping tool comprises at least one press jaws having a square cross section or a hexagonal cross section in the closed state.

16. The method for producing a crimp connection according to claim 13, wherein the crimp connection is made by rotary swaging.
